(19) United States
(12) Patent Application Publication
(10) Pub. No.: US 2007/0267828 A1
(43) Pub. Date: Nov. 22, 2007

(54) Apparatus for Inhibiting Germ Transmission from Shopping Cart Handles

(76) Inventor: Joseph Egizi, Pasadena, CA (US)

Correspondence Address: West & Associates, A PC, Suite 209, 2815 Mitchell Drive, Walnut Creek, CA, 94598, US

(21) Appl. No.: 11/750,989

(22) Filed: May 18, 2007

Related U.S. Application Data
(60) Provisional application No. 60/802,066, filed on May 18, 2006.

(51) Int. Cl. B62D 39/00

(52) U.S. Cl. 280/33.992

(57) ABSTRACT

An elastically deformable cover adapted to selectively engage a shopping cart handle. In some embodiments, the cover can include a single color and/or multiple colors. In some embodiments, the cover can include a message space adapted to receive and/or include a massage.

### PRIORITY CLAIM

This application claims the benefit of U.S. Provisional patent application No. 60/802,066 filed May 18, 2006.

### BACKGROUND

1. Field of the Invention

The present invention is related to apparatuses for inhibiting the transmission of germs from the handles of shopping carts.

2. Description of the Related Art

The widespread use of shopping carts in supermarkets, some department stores and other retail merchandise establishments has greatly simplified shopping for the consumer. The cart allows consumers to pick up a plurality of desired items for purchase and place them in the cart, while keeping their hands free and affording them mobility to move through the store while shopping.

Shopping carts are used by hundreds of people per week and the handles of such carts are rarely, if ever, properly sanitized by the stores owning such carts. As a result, millions of germs (bacterial and viral) and skin-borne infections agents are transmitted from person to person by the use of such shopping carts. Each successive shopper handling the cart comes into contact with the germs of the prior shopper, and further deposits his own germs.

Recently, stores have begun to offer sanitizing wipes to consumers to clean and sanitize the handle of the cart before they begin using the cart. Additionally, the stores themselves sanitize their shopping carts periodically. However, the periodic sanitization does not really solve any problems, since the handles are quickly re-infested with germs immediately after the sanitization process is complete.

A further, related problem concerns infants and small children, who, while seated in a shopping cart, often teeth on or chew on the handle, thereby coming into immediate oral contact with this source of germs. While a shopper could wear gloves to protect himself from the handle, this would not prevent a child from teething on or otherwise orally contacting the exposed handle.

What is needed is an apparatus capable of inhibiting the transmission of germs from one party to the next via the handles of shopping carts.

### BRIEF DESCRIPTION OF THE DRAWINGS

FIG. 1 depicts one embodiment of a shopping cart handle cover.

FIG. 2 depicts a side view of the shopping cart handle cover shown in FIG. 1.

FIG. 3 depicts a cross-sectional view of an alternate embodiment of the shopping cart handle cover.

FIG. 4 depicts a cross-sectional view of an alternate embodiment of the shopping cart handle cover.

FIG. 5 depicts an alternate embodiment of the shopping cart handle cover shown in FIG. 1.

FIG. 6 depicts a cross-sectional view of an alternate embodiment of the shopping cart handle cover.

FIG. 7 depicts a cross-sectional view of an alternate embodiment of the shopping cart handle cover.

FIG. 8 depicts a cross-sectional view of an alternate embodiment of the shopping cart handle cover.

FIG. 9 depicts a cross-sectional view of an alternate embodiment of the shopping cart handle cover.

FIG. 10 depicts a cross-sectional view of an alternate embodiment of the shopping cart handle cover.

FIG. 11 depicts a cross-sectional view of an alternate embodiment of the shopping cart handle cover.

FIG. 12 depicts a system for inhibiting germs transmission from shopping cart handles.

FIG. 13 depicts a cross-sectional view of an alternate embodiment of the shopping cart handle cover.

FIG. 14 depicts a cross-sectional view of an alternate embodiment of the shopping cart handle cover.

FIG. 15 depicts an alternate embodiment of the shopping cart handle cover depicted in FIG. 1.

FIG. 16 depicts an alternate embodiment of the shopping cart handle cover depicted in FIG. 1.

### DETAILED DESCRIPTION

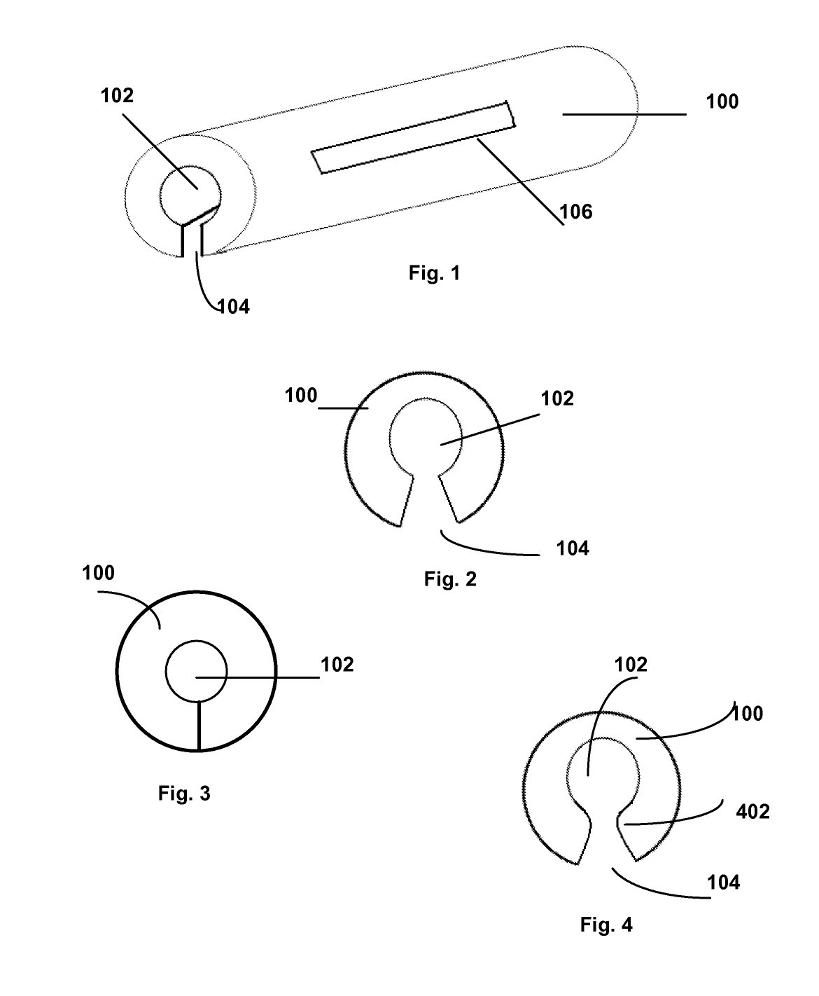

FIG. 1 depicts one embodiment of a shopping cart handle cover 100. In the embodiment shown in FIG. 1, the shopping cart handle cover 100 is comprised of a single semi-cylindrical element having a central bore 102 and a truncated pie-shaped cut-out 104, each running the complete length of the cover 100. In alternate embodiments, the cover 100 can have any known and/or convenient geometric properties.

In the embodiment shown in FIG. 1, the cover 100 can be comprised of an elastically deformable foam material, such as closed-cell polyethylene foam and/or any other known and/or convenient material. In some embodiments, the material can be selected such that it is soft to the touch a compared to the metal and/or plastic handle of most shopping carts. Additionally, in some embodiment the material can be selected such that it has a lower coefficient of thermodynamic transfer than the metal or plastic (that is, it will be less likely to become hot and/or cold like typical shopping cart handles). In the embodiment shown in FIG. 1, the cover 100 can have a single color that is integral with the material and/or can be multi-colored. In some embodiments, the color can be placed on the material after the cover is formed.

In the embodiment shown in FIG. 1, the cover 100 can include a recessed, flush and/or protruded message area 106. The message area 106 can be designed to include any message in any form that a user desires and/or can be adapted to display a message which can be modified by a user.

In the embodiment shown in FIG. 1, the central bore 102 is adapted such that when the cover 100 is selectively engaged with the handle of a shopping cart, the cover 100 will frictionally engage the shopping cart handle such that substantial rotation of the cover 100 relative to the shopping cart handle is inhibited.

In the embodiment shown in FIG. 1, the cut-out 104 is adapted to allow a user to selectively couple the cover 100 with a shopping cart handle. In alternate embodiments the cut-out 104 can have any known and/or convenient shape and/or dimensions.

FIG. 2 depicts a side view of the embodiment shown in FIG. 1. In the embodiment shown in FIG. 2, the bore 102 is located substantially along the central axis of the cover 100. However, in alternate embodiments, the bore 102 can be located at any known and/or convenient location within the body of the cover 100.

In the embodiment shown in FIG. 2, the central bore is shown as being generally cylindrical. However in alternate embodiments, the bore 102 can have a star shape, a rectangular shape, a square shape and/or have any known and/or convenient geometric properties.

In the embodiment shown in FIG. 2, the cut-out 104 is shown having a truncated pie shape. However, in some embodiments the cut-out 104 can be rectangular, can be a cut and/or can have any known and/or convenient geometric properties.

In the embodiment depicted in FIG. 3, the bore 102 can be substantially cylindrical, but can vary in dimensions along the length of the cover 100. Additionally, the cut-out 104 can be a simple cut extending from the exterior of the cover 100 to the bore 102.

In the embodiment depicted in FIG. 4, the bore 102 can be semi-circular and the intersection 402 with the cut-out 104 can be configured to have a rounded geometry and/or any known and/or convenient geometry to facilitate coupling and decoupling of the cover 100 with the handle of a shopping cart and/or other handle.

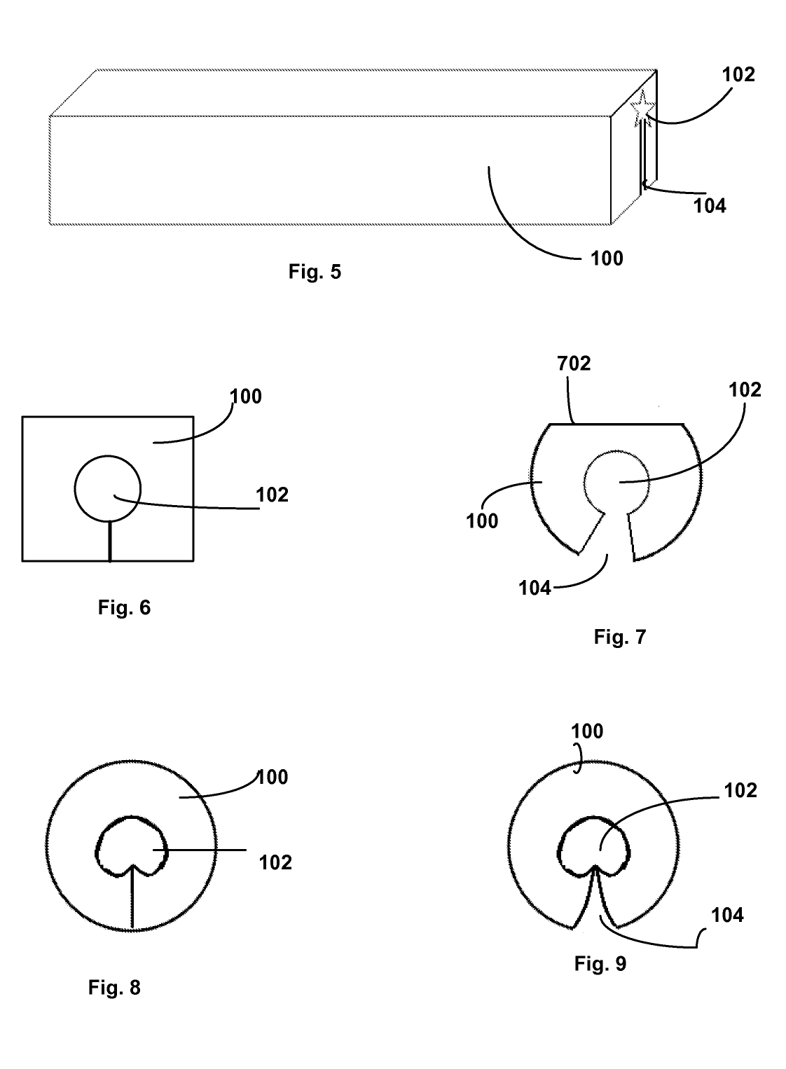

FIG. 5 depicts an alternate embodiment of the cover 100 shown in FIG. 1. In the embodiment shown in FIG. 3, the cover 100 is substantially square in cross-section and has a star shaped bore 102, which can be located in any convenient geometric relation relative to the longitudinal centerline of the cover 100.

In the embodiment shown in FIG. 5, the cut-out 104 is a cut extending from the exterior surface of the cover 100 to the bore 102.

In the embodiment depicted in FIG. 6, the cover 100 can have a rectangular shape and the bore 102 can be circular. However, in alternate embodiments the cover can have any known and/or convenient geometric shape and the bore 102 can have any known and/or convenient shape and be located in any convenient geometric relation relative to the cover 100.

FIG. 7 depicts an alternative embodiment of the cover 100 in which the cover 100 includes a substantially flat surface 702 and in which the bore 102 is offset from the central longitudinal axis of the cover 100.

FIGS. 8 and 9 depict alternate embodiments of the cover 100 in which the bore 102 has an inverted apple shape. In the embodiment depicted in FIG. 9, the cut-out has curved interior walls that open to the exterior of the cover 100.

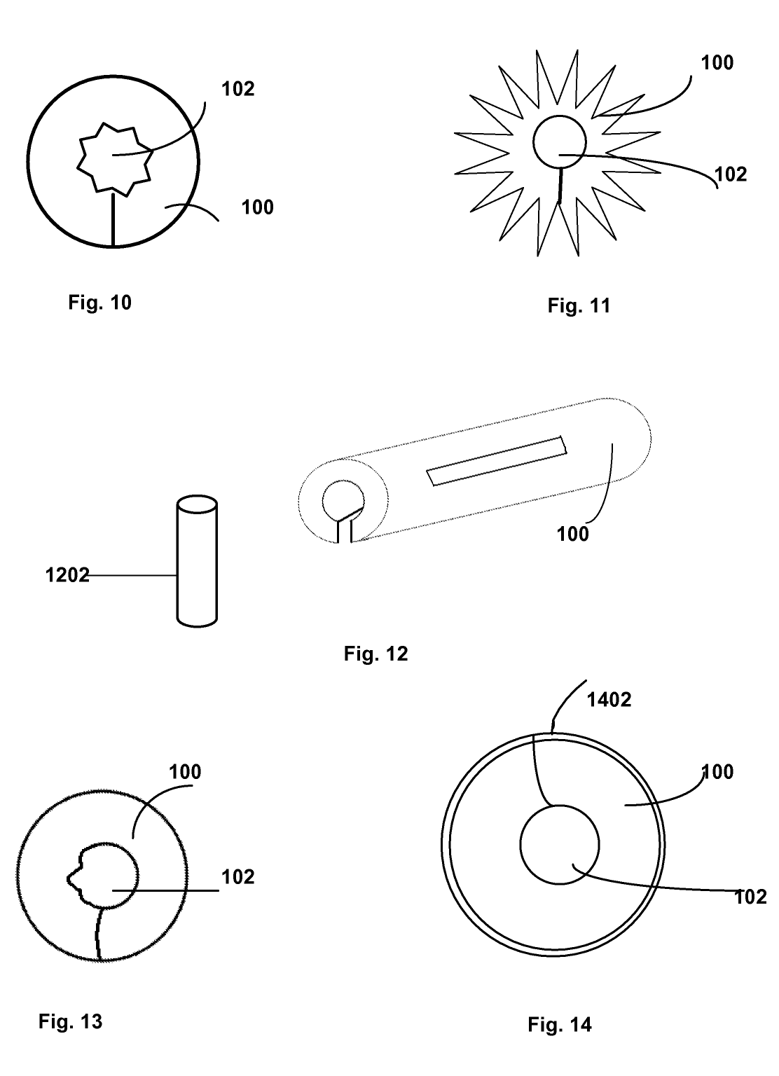

FIGS. 10 and 11 depict alternate embodiments of the cover 100. In the embodiment depicted in FIG. 10, the bore 102 has a multi-pointed star shape that can be dimensioned to frictionally engage the handle of a shopping cart. The embodiment depicted in FIG. 11 shows that in some embodiments the exterior surface of the cover 100 can have an irregular shape, such a multi-pointed star and/or any other known and/or convenient shape. In such embodiments the cover 100 can be comprised of a soft material such that exterior surface of the cover 100 does not pose a risk of injury.

FIG. 12 depicts an embodiment of a system comprising a notched cover 100, as detailed herein, and a germicidal solution 1202. In the embodiment depicted in FIG. 12, the germicidal solution can be applied to the cover at any convenient time. The germicidal solution can be any known and/or convenient germicidal solution capable of disinfecting the cover 100 and/or providing and/or impregnating the cover 100 with any desired germicidal properties.

FIG. 13 depicts a cross-sectional view of an alternate embodiment of the cover 100 in which the bore 102 is substantially circular, but includes a notch. The notch can be adapted and/or configured to selectively engage handles which have finger alignment protrusions.

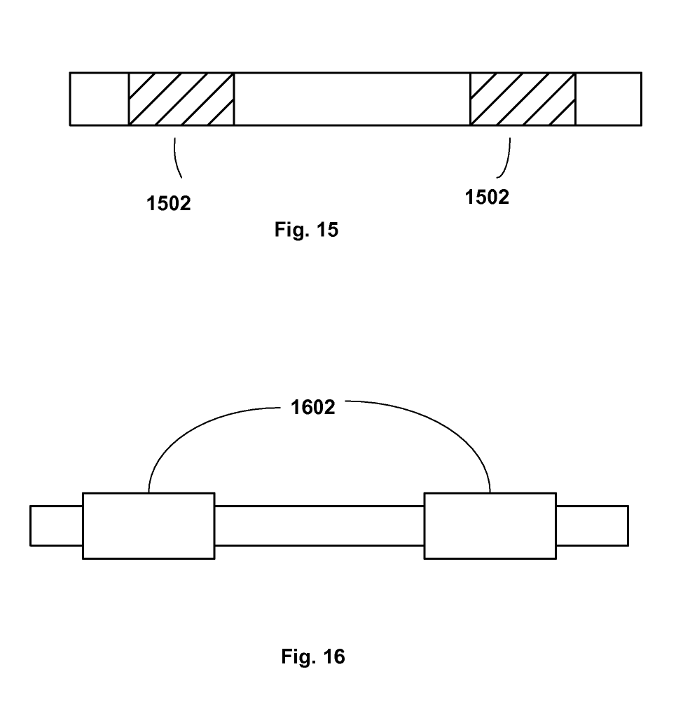

FIG. 14 depicts a cross-sectional view of an alternate embodiment of the cover 100 in which the cover includes a perimeter layer 1402. In some embodiments the perimeter layer 1402 can be impregnated, infused and/or otherwise associated with a desired germicidal and/or anti-bacterial compound and the perimeter layer can be coupled with the cover 100. In some embodiments the perimeter layer can be configured to slowly erode and/or dissolve at a desired rate to continually expose a new layer of material—thus constantly renewing the anti-bacterial/germicidal properties of the cover 100. Moreover, in some embodiments the perimeter layer can be configured to visually indicate when the useful life of the anti-bacterial/germicidal properties of the cover are nearing extinction. In some embodiments, the perimeter layer 1402 can be comprised of a material having a different color and/or texture than the cover 100. Thus, when the cover material wears off a color variation would be evident, indicating that the product has come to the end of its useful life. In alternate embodiment the cover can provide any known and/or convenient indication to a user that the cover's 100 germicidal/anti-bacterial properties are at or near their end.

FIG. 15 depicts an embodiment in which the cover 100 can include distinct regions 1502 in which it is desired that a user place his/her hands. In some embodiments, such areas may have higher impregnations of a germicidal/anti-bacterial compound and/or they may simply be decorative.

FIG. 16 depicts an embodiment in which the cover 100 can be divided into two individual hand grips 1602, which can have any desired properties.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. An apparatus to inhibit germ transmission comprising:
an elastically deformable cover;
a bore located substantially parallel a longitudinal axis of said cover; and
a cut-out coupling the exterior of said elastically deformable cover and said bore;
wherein the exterior of said elastically deformable cover includes at least one color; and
wherein said bore is adapted to selectively engage a shopping cart handle.
